(19) United States
(12) Patent Application Publication
(10) Pub. No.: US 2005/0240750 A1
(43) Pub. Date: Oct. 27, 2005

(54) INTERLEAVED MAPPING METHOD AND APPARATUS FOR ACCESSING MEMORY

(75) Inventor: Kevin Lin, Taipei (TW)

Correspondence Address: SQUIRE, SANDERS & DEMPSEY L.L.P, 600 HANSEN WAY, PALO ALTO, CA, 94304-1043, US

(73) Assignee: VIA TECHNOLOGIES, INC., Taipei (TW)

(21) Appl. No.: 10/711,843

(22) Filed: Oct. 8, 2004

Related U.S. Application Data
(63) Continuation-in-part of application No. 10/709,296, filed on Apr. 27, 2004.

(51) Int. Cl. G06F 12/08

(52) U.S. Cl. 711/203; 711/5; 711/105

(57) ABSTRACT

This invention provides a method for accessing memory. The method includes, generating a block index for a block of data, mapping the block index to a physical address of a memory based on the block index and a number N, wherein N is bank number of the memory, storing the block of data into the memory at the physical address, and repeating from the generating step, wherein the mapping step makes each one of the block indexes map in turns to one physical address located at different banks, and result in any logical adjacent block of data be stored physically at different banks of the memory.

### CROSS-REFERENCE TO RELATED APPLICATION

This is a continuation-in-part of and incorporates by reference U.S. patent application Ser. No. 10/709,296, filed Apr. 27, 2004.

### FIELD OF THE INVENTION

This invention relates to a method and an apparatus for accessing memory. Specifically, it relates to a method and an apparatus for reducing pre-charge overhead when accessing memory.

### DESCRIPTION OF THE RELATED ART

In recent years, growing speed of computer industry is more and more fast, and almost everyone has his own PC. Moreover, computer is utilized to do everything, such as data processing, data recording, information management, multi-media playing, and so on. Computer system is a combination of hardware software, and firmware, wherein hardware comprises processor, memory, drive, graphic card and so forth. For efficiency of the system, corporation between these hardware is important, especially co-work between processor and memory. In addition, configure of the memory is also concerned with efficiency.

Referring to FIG. 1, it is a schematic diagram of conventional memory configuration. For example, external SDRAM is partitioned into several blocks in unit of the same size to fit a CD/DVD ECC block (1 sector for CD-ROM or 16 sectors for DVD-ROM). Each block is pointed by a block index i, with the next adjacent one pointing by a block index i+1. A ring buffer is constructed when the block index i is constrained within 0˜ (Imax-1), where Imax represents the maximum block number stored in buffer. In FIG. 1, the sector 12 of the optical disc 90 is retrieved to a block of data 22, and the block of data 22 is stored in the block 32 pointed by index 0. The sector 14 of the optical disc 90 is retrieved to a block of data 24, and the block of data 24 is stored in the block 34 pointed by index 1. The sector 16 of the optical disc 90 is retrieved to a block of data 26, and the block of data 26 is stored in the block 36 pointed by index 2. The sector 18 of the optical disc 90 is retrieved to a block of data 28, and the block of data 28 is stored in the block 38 pointed by index 3. These blocks of data are stored in the external SDRAM in sequence physically.

In the optical playing system, the pipeline operation in response to a disc read command is done as following: Pipe(a) sequentially buffers incoming blocks of data into successive memory blocks i, i+1, i+2, . . . , and so on; Pipe(b) sequentially decodes blocks which are buffered in Pipe(a). Most bandwidth of external memory is occupied by Pipe(a)-Pipe(b) while storing data into the external SDRAM.

On the contrary, the pipeline operation in response to a disc write command is done as following: Pipe(a) sequentially receives user blocks from host and buffers them into successive memory blocks i, i+1, i+2, and so on; Pipe(b) sequentially encodes blocks which are buffered in Pipe(a). Most bandwidth of external memory is occupied by Pipe(a)-Pipe(b) while writing (recording) data into a optical disc. Because this operation or data accessing are similar to the pipeline operation in response to a disc reading, there is no further drawing about the pipeline operation in response to a disc writing.

Note that in read pipeline operation, Pipe(b), as a channel decoder, decodes a sector from streaming Pipe(a) once it is ready in buffer. They are most likely to be working over two sectors with adjacent indexes. Moreover, in write pipeline operation, Pipe(b), as a channel encoder, encodes a sector from host Pipe(a) once it is ready in buffer. They are most likely to be working over two sectors with adjacent indexes. However, it needs pre-charge operation between two accessing operations over the same bank but different rows of a SDRAM. Note that the size of a CD/DVD sector results in different rows accesses over a SDRAM while Pipe(a) and Pipe(b) are active. Therefore, the SDRAM needs pre-charge operation of the Bank(0) after accessing the block 36 of the Bank(0) by the Pipe(a) in order to continue accessing the block 34 of the Bank(0) by the Pipe(b). That is, the SDRAM needs pre-charge operation between two Pipes access the same bank.

The conventional method is very straightforward since it uses sequential block addressing, and it provides a convenient way while mapping target sector (to or from disc) to physical address of SDRAM. However, during a read command, pipeline operations of Pipe(a) and Pipe(b) tend to access the same bank of the SDRAM buffer, since at most time Pipe(a) is just one sector ahead of Pipe(b). On the other hand, during a write command, pipeline operations of Pipe(a) and Pipe(b) tend to access the same bank of the SDRAM buffer, since at most time Pipe(a) is just one sector ahead of Pipe(b). The conventional method leads to too much same-bank-access of Pipe(a)-Pipe(b) during a disc read or writes operation and needs much pre-charge overheads between these same-bank-accesses.

Referring to FIG. 2, it is a schematic diagram for showing disadvantage of accessing SDRAM according to the conventional method. It shows the SDRAM needs pre-charge operation between two Pipes access the same bank. At time axis, Pipe(a) accesses the Bank(0) in T0 before Pipe(b) accesses the Bank(0) in T1, so the Bank(0) needs pre-charge operation in ΔT. The pre-charge operations are surely overheads in the optical storage system.

### SUMMARY OF THE INVENTION

This invention provides a method for accessing memory. The method comprises generating a block index for a block of data; mapping the block index to a physical address of a memory based on the block index and a number N, wherein N is bank number of the memory; storing the block of data into the memory at the physical address; and repeating from the generating step, wherein the mapping step makes each one of the block indexes map in turns to one physical address located at different banks, and result in any logical adjacent block of data be stored physically at different banks of the memory.

This invention also provides an apparatus for operating a disc player with a memory. The apparatus comprises means for retrieving a block of data from a source media, means for assigning a block index for the block of data, means for dividing value of the block index by N for acquiring a quotient Q and a reminder R, wherein N is bank number of the memory, means for calculating the physical address based on Q and R, and means for accessing the block of data in the memory at the physical address, wherein the calculating means makes the block index interleaved mapping to the physical address located at different banks and any two logically successive blocks of data be stored physically at different banks of the memory.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings.

FIG. 1 is a schematic diagram of conventional memory configuration.

FIG. 2 is a schematic diagram for showing disadvantage of accessing SDRAM according to the conventional method.

FIG. 3 is a flowchart according to the present invention.

FIG. 4 is a flowchart of S92 shown in FIG. 3.

FIG. 5 is a schematic diagram for memory configuration and data storage according to the present invention.

FIG. 6 is a schematic diagram for showing an advantage of accessing memory according to the present invention.

FIG. 7 is a schematic diagram for displaying an apparatus according to the present invention.

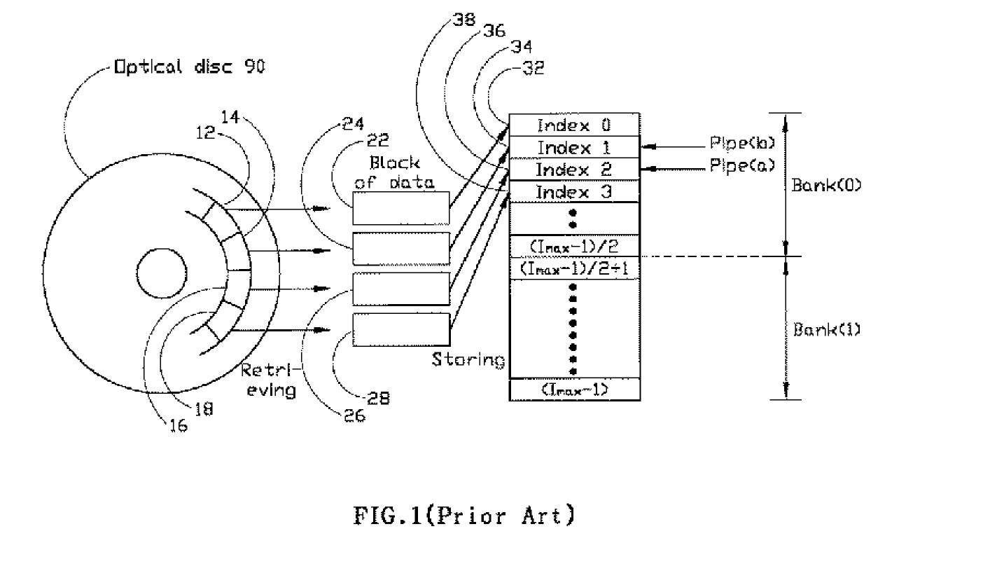

### DETAILED DESCRIPTION

Some preferred embodiments are given as following to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore the present invention is not intended to be limited to the particular embodiments shown and described herein, but is to be accorded the widest herein disclosed.

In one aspect, the present invention is directed to provide a method for accessing memory.

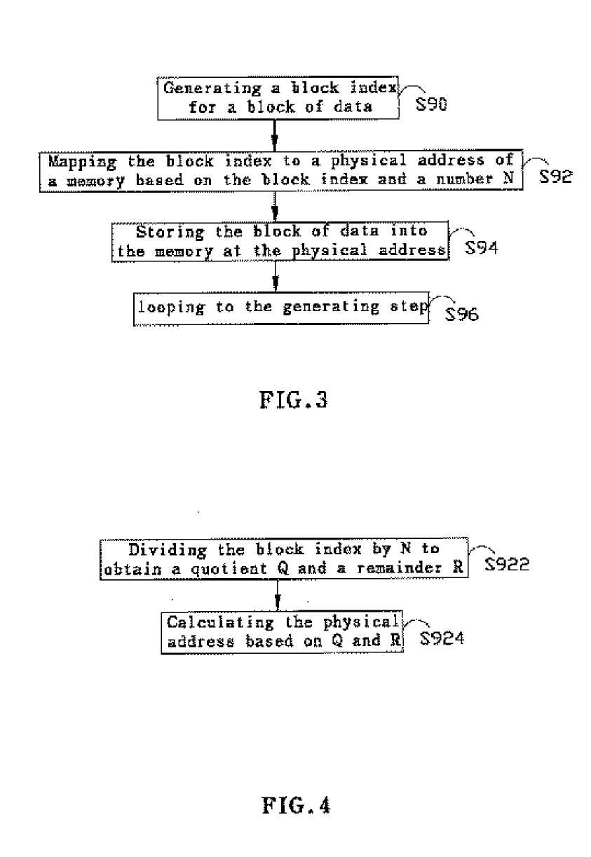

Referring to FIG. 3, it is a flowchart according to the present invention. This invention comprises the steps of:
Step S90: generating a block index for a block of data.
Step S92: mapping the block index to a physical address of a memory based on the block index and a number N, wherein N is bank number of the memory.
Step S94: accessing the block of data into the memory at the physical address.
Step S96: repeating from the generating step S90.

Referring to FIG. 4, it is a flowchart of S92 shown in FIG. 3. In Step S92, the mapping step comprises:
Step 922: dividing the block index by N to obtain a quotient Q and a remainder R.
Step 924: calculating the physical address based on Q and R, wherein the physical address=Q*block_size+R*bank_size.

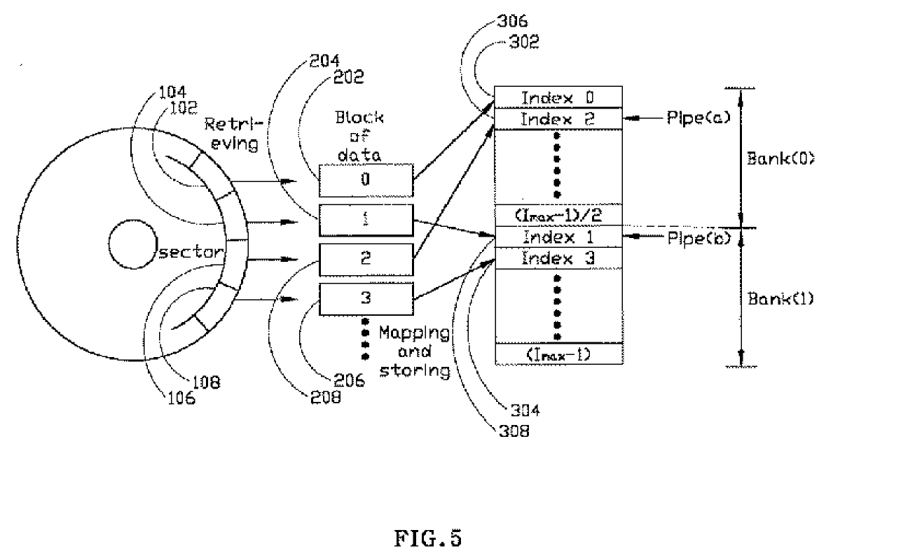

In one embodiment, referring to FIG. 5, each sector of an optical disc 100 is retrieved successively to be a block of data and block indexes are assigned to each block of data in sequence. In the other hand, the memory is divided into two banks, i.e. N=2, and blocks of each bank is configured to fit size of the block of data. The operation of Pipe(a) is as follows, for example, sector 102 is retrieved to be a block of data 202 and assigned a block index 0, mapping block index 0 to physical address 302, storing the block of data 202 into the memory block located at the physical address 302, and repeating these steps again for successively sectors. For instance, sector 104 is retrieved to be a block of data 204 and assigned a block index 1, mapping block index 1 to physical address 304, storing the block of data 204 into the memory block located at the physical address 304; sector 106 is retrieved to be a block of data 206 and assigned a block index 2, mapping block index 2 to physical address 306, storing the block of data 206 into the memory block located at the physical address 306; sector 108 is retrieved to be a block of data 208 and assigned a block index 3, mapping block index 3 to physical address 308, storing the block of data 208 into the memory block located at the physical address 308. The steps from the retrieving step to the storing step for rest sectors of the optical disc 100 are similar to the above explanation and correlation graphical representation, therefore no longer gives unnecessary detail in this.

In addition, the mapping step comprises several steps, as follow:

Dividing the block index by 2 to obtain a quotient Q and a remainder R and calculating the physical address based on Q and R, wherein the physical address=Q*block_size+R*bank_size. For example, dividing the block index 0 by 2 to obtain a quotient Q=0 and a remainder R=0, calculating the physical address based on Q=0 and R=0 by using the formula, the physical address=Q*block_size+R*bank_size, wherein the bank_size=memory size/2, and the block_size=the size of one sector of the optical disc, and the result, the physical address 302, is located at the Bank(0). In the same reason, for the sector 104, dividing the block index 1 by 2 to obtain a quotient Q=0 and a remainder R=1, calculating the physical address based on Q=0 and R=1 by using the formula, and the result, the physical address 304, is located at the Bank(1). The steps for the others sector are the similar to the above explanation and correlation graphical representation, therefore no longer gives unnecessary detail in this.

At the same time, the Pipe(b) is followed by Pipe(a), the operation of Pipe(b) is to decode the block just accessed by Pipe(a) base on the same reference function. Note that the physical address 302 and the physical address 306 are located at the same bank, Bank(0), and the physical address 304 and the physical address 308 are located at the same bank, Bank(1). Consequently, we can see that any logical adjacent block of data be stored physically at different banks of the memory.

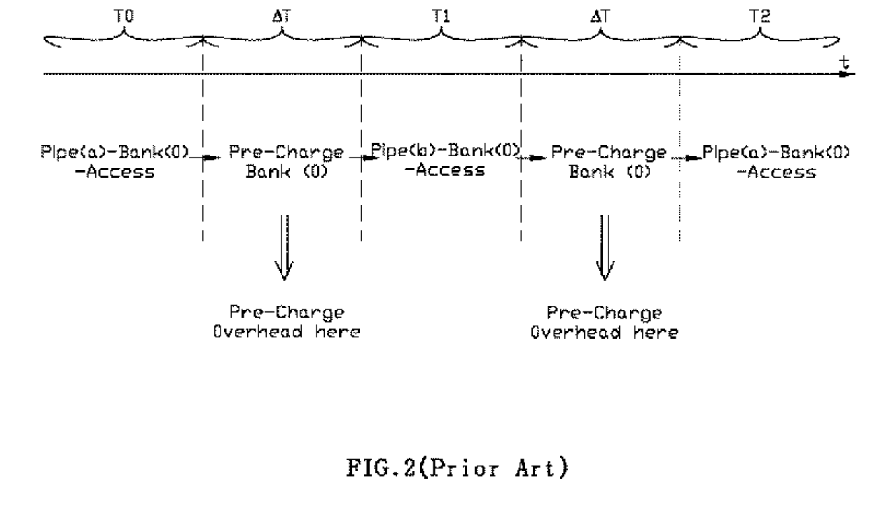

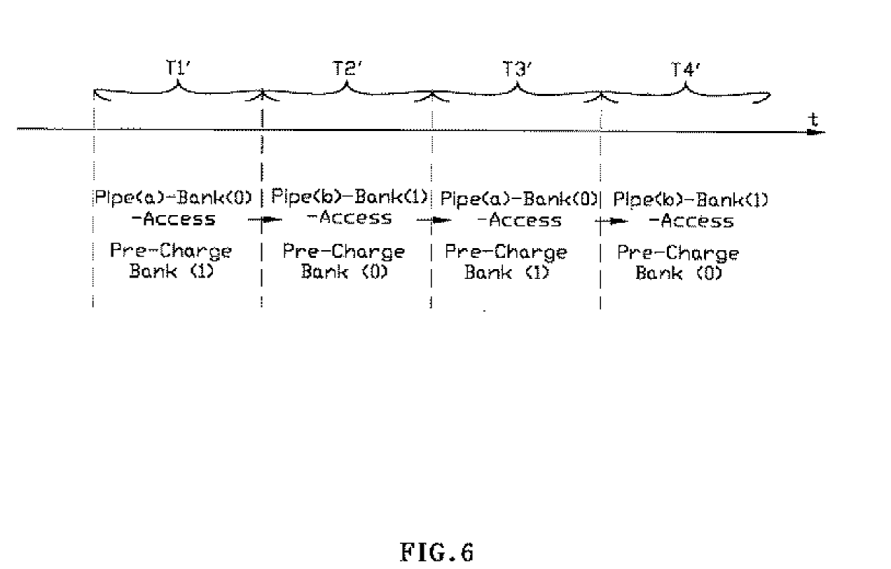

Referring to FIG. 6, it is a schematic diagram for showing an advantage of accessing memory according to the present invention. The pre-charge time of one bank is combined with the accessing time of another bank, that is, the pre-charge operation of one bank and the accessing operation of another bank are at the same time slot. Due to the method according to this invention, Pipe(a) accesses one bank and then Pipe(b) can access another bank at the same period. Therefore, Pipe(a) accesses Bank(0) at T0′ and the pre-charge operation of Bank(1) is executed at the same time. Pipe(b) accesses Bank(1) at T1′ and the pre-charge operation of Bank(0) is also executed at the same time. The pre-charge time of Bank(1) is combined with the Pipe(a)-Bank(0)-Access, and the pre-charge time of Bank(0) is combined with the Pipe(b)-Bank(1)-Access. Comparing to FIG. 2, there is no pre-charge overheads between memory access of Pipe(a) and Pipe(b).

In another aspect, the present invention is directed to provide an apparatus for accessing memory.

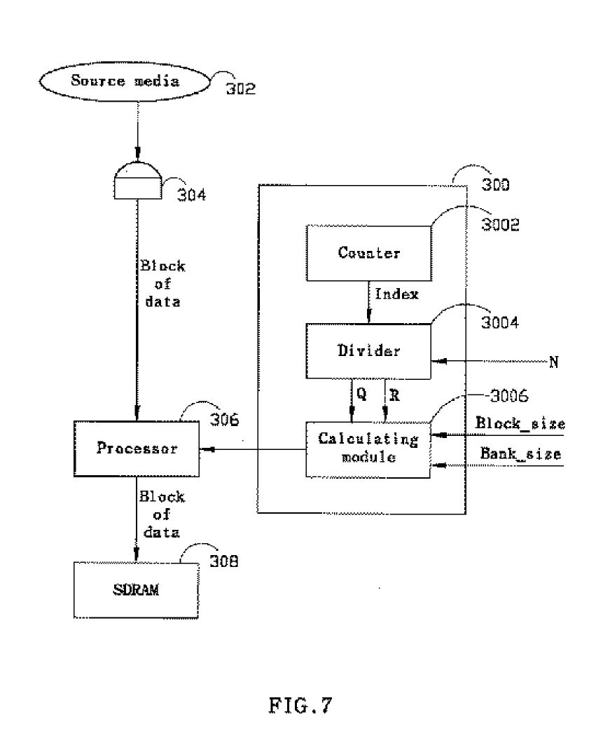

Referring to FIG. 7, it is a schematic diagram for displaying an apparatus according to the present invention. FIG. 7 includes an apparatus 300 provided by this invention, a source media 302, a pick-up head 304 coupled to the source media, a processor 306 coupled to the pick-up head 304, and a SDRAM 308 coupled to the processor 306. The apparatus 300 comprises a counter 3002, a divider 3004 coupled to the counter 3002, and a calculating module 3008 coupled to the divider 3004. When the pick-up head 304 retrieves a block of data from the source media 302, the counter 3002 generates an index for the block of data at the same time. The index is divided by the bank number N for acquiring a quotient Q and a reminder R in the divider 3004, wherein the bank number N is provided by the outside signal, for example, the processor of a PC. The calculating module 3006 calculates the physical address based on the quotient Q, the reminder R, bank_size and block_size, wherein bank_size and block_size are defined by programming according to system configuration. In addition, the calculating module 3006 comprises a plurality of logic gates to implement a reference function to calculate the physical address, for instance, the reference function is “the physical address=Q*block_size+R*bank_size”. Finally, the processor 306 stores the block of data into the SDRAM 308 according to the physical address received from the calculating module 3006.

This invention provides an apparatus and a method for accessing memory. Specifically, it relates to a method and an apparatus for reducing pre-charge overhead when accessing memory. Comparing to conventional method, there is no pre-charge overhead when the optical disc player accesses the external memory according to this invention. It reduces accessing time when writing data into memory and decoding data from memory.

Finally, those skilled in the art should appreciate that they can readily use the disclosed conception and specific embodiment as a basis for designing or modify other structures for carrying put the same purpose of the present invention without departing from the spirit and scope of the invention as defined by the appended claims.

1. A method for accessing memory, comprising:
generating a block index for a block of data;
mapping the block index to a physical address of a memory based on the block index and a number N, wherein N is bank number of the memory;
storing the block of data into the memory at the physical address; and
looping to the generating step,
wherein the mapping step makes each one of the block indexes map in turns to one physical address located at different banks, and result in any logical adjacent block of data be stored physically at different banks of the memory.

2. The method of claim 1, wherein the memory supports pipelining access.

3. The method of claim 1, wherein the memory is a SDRAM.

4. The method of claim 1, the mapping steps further comprises:
dividing the block index by N to obtain a quotient Q and a remainder R; and
calculating the physical address based on Q and R, wherein the physical address=Q*block_size+R*bank_size.

5. The method of claim 4, wherein bank_size equals the memory size divided by N, and block_size equals the size of which the system is in need to process one sector from the optical disc.

6. A method of operating a disc player with a memory comprising:
retrieving a block of data from a source media;
assigning a block index for the block of data;
dividing value of the block index by N for acquiring a quotient Q and a reminder R, wherein N is bank number of the memory;
calculating the physical address based on Q and R;
storing the block of data in the memory at the physical address; and
repeating form the retrieving step, wherein the calculating step makes the block index interleaved mapping to the physical address located at different banks and any two logically successive blocks of data be stored physically at different banks of the memory.

7. The method of claim 6, wherein the memory supports pipelining access.

8. The method of claim 6, wherein the memory is a SDRAM.

9. The method of claim 6, wherein the calculating step further comprises a reference function, as follows:
the physical address=Q*block_size+R*bank_size.

10. The method of claim 9, wherein bank_size equals the memory size divided by N, and block_size is bank_size divided into a plurality of parts.

11. The method of claim 9, further comprises:
reading the block of data according to the block index and the reference function; and
recording the block of data to a destination media, whereby the reading step makes each one of the block of data read at different banks in turns and result in time saving and reduces pre-charge overloads by reading in one bank and pre-charge in another bank accessed just before.

12. An apparatus for processing digital data with a memory in a disc player, comprising:
means for generating a block index for the block of data;
means for dividing value of the block index by N for acquiring a quotient Q and a reminder R, wherein N is bank number of the memory; and
means for calculating the physical address based on Q and R, wherein the calculating means makes the block index interleaved mapping to the physical address located at different banks and any two logically successive blocks of data be stored physically at different banks of the memory.

13. The apparatus of claim 12, wherein the memory supports pipelining access.

14. The apparatus of claim 12, wherein the memory is a SDRAM.

15. The apparatus of claim 12, wherein the means for calculating implements a reference function as follow:
the physical address=Q*block_size+R*bank_size.

16. The apparatus of claim 15, wherein bank_size equals the memory size divided by N, and block_size is bank_size divided into a plurality of parts.

17. A method for accessing memory, comprising:
generating a plurality of block indexes for a plurality of blocks of data;
mapping the block indexes sequentially to a plurality of physical address of a memory based on the block indexes and a number N, wherein N is bank number of the memory; and
storing the block of data into the memory at the physical address, wherein the mapping step makes each one of the block indexes map in turns to one physical address located at different banks, and result in any logical adjacent block of data be stored physically at different banks of the memory.

18. The method of claim 17, wherein the memory supports pipelining access.

19. The method of claim 17, wherein the memory is a SDRAM.

20. The method of claim 17, the mapping steps further comprises:
dividing the block index by N to obtain a quotient Q and a remainder R; and
calculating the physical address based on Q and R, wherein the physical address=Q*block_size+R*bank_size, bank_size equals the memory size divided by N, and block_size equals the size of a plurality of sectors on the optical disc.
